(19) United States
(12) Patent Application Publication
(10) Pub. No.: US 2007/0175119 A1
(43) Pub. Date: Aug. 2, 2007

(54) Window awning/storm panel system

(76) Inventor: Rayburn A. Haynie, Seadrift, TX (US)

Correspondence Address: Rayburn A. Haynie, 302 West Baltimore Avenue, P.O. Box 126, Seadrift, TX, 77983, US

(21) Appl. No.: 11/331,749

(22) Filed: Jan. 13, 2006

(51) Int. Cl. E06B 3/964

(52) U.S. Cl. 52/204.61

(57) ABSTRACT

An attractive window awning/storm panel system, that quickly converts from a window awning into a storm panel from the inside of the house. The window awning/storm panel system will help reduce utility bills, reduce harmful ultraviolet sunrays, and can be manufactured to fit most standard size single or double hung vertical slide windows. The window awning/storm panel system includes one upper and one lower panel, made of impact resistant material. The upper panel is slightly larger than the lower panel. One pair of hinge locking braces are connected between the upper and lower panels. The opposite ends of the braces are secured to the window facing with 90° deck hinges. One piano hinge is used to connect the top side of the upper panel to the top window facing; one spring-loaded latch for securing the lower panel in the up position; and only a few bolts, washers, nuts and fasteners are necessary for the Installation and operation of the window awning/storm panel system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

The major advantage of my Window Awning/Storm Panel System is the total operation of converting the window awning into a storm panel from inside the home or office building. In general, weather forecasters are predicting a larger number of storms in the upcoming years. While property owners realize the need to protect their windows, frequently outer bands of rain precede the oncoming hurricane or storm and thus prevents the property owner from taking proper precautions to cover their windows. High winds and heavy rains do not allow for the outdoor activities of boarding windows, as you cannot struggle with sheets of plywood during this type of inclement weather. Property owners can enjoy the benefits of an attractive window awning throughout the seasons and then quickly convert this awning into a storm panel when a storm approaches. This conversion can be easily made from inside their dwelling. This distinct advantage will be well appreciated by property owners in storm prone areas along all coastlines.

The window awning/storm panel system, which I have invented, can be made smaller or larger to accommodate most single-hung and double-hung vertical slide windows. This feature will be extremely helpful for two-story homes or for elevated houses which are quite popular in many coastal areas.

Color coordinating the window awning/storm panel system to the property owners desired color scheme will make the system very popular. Homeowner associations will welcome my very attractive and functional window awning/storm panel system.

Ease of operation of the storm panel system will be most beneficial to all property owners. Special tools are not required to open or close the system. A great deal of strength is not required and senior citizens can be confident of their ability to operate the system. The property owner's inside screens will prevent children from operating the system.

In case of any type of emergency, the closed panel system can be quickly and easily opened to allow exit through the window. No special tools or time delaying devices are required to reopen the closed panel in the event the window is needed for an exit during an emergency. This feature is most comforting to families during a long lasting storm or lengthy hurricane.

### BRIEF SUMMARY OF THE INVENTION

It is an objective of my window awning/storm panel system to provide the property owner with a desperately needed alternative to the very difficult, and sometimes last minute task, of protecting the windows of their home during a hurricane or tropical storm.

It is also an objective of my window awning/storm panel system to provide an attractive impact resistant storm panel for the outside windows. It is further the objective of my window awning/storm panel system to provide the property owner with a window protection system that is constructed of an impact resistant material that will pass the large missile test. This test is performed by shooting an approximately 9 foot long, nine pound 2×4 from an air cannon at 34 mph into the storm panel system.

It is further the objective of my window awning/storm panel system to provide a very attractive window awning, that can be color coordinated and enhance the appearance of the home. Awnings further provide protection from harmful ultraviolet sun rays, while lowering utility bills.

It is also an objective of my window/awning storm panel system to provide complete window covering thereby deterring unauthorized entry to the home while the property owners are away for extended periods of time. The panel can be locked or unlocked from the inside of the building in order to provide the occupant a means of escape in case of an emergency.

### BRIEF DESCRIPTION OF THE DRAWINGS

FIG. 1 is a perspective isometric drawing of my window awning/storm panel system and its relationship to the window.

FIG. 2 is a detailed exploded view of my window awning/storm panel system.

FIG. 3 is a detailed back view of my window awning/storm panel system.

FIG. 4 is a front view of my window awning/storm panel system.

FIG. 5 is a side view of my window awning/storm panel system, showing both open and closed positions.

### DETAILED DESCRIPTION OF THE INVENTION

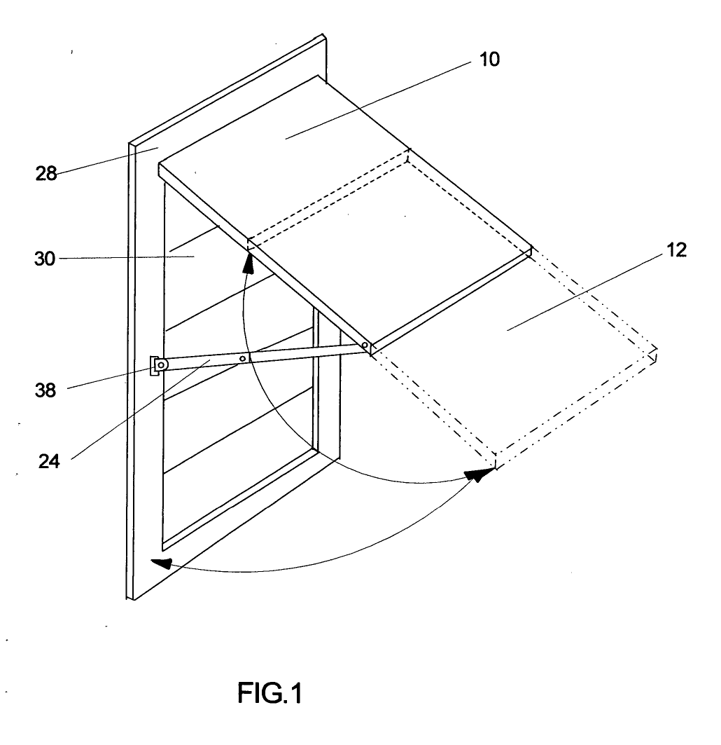

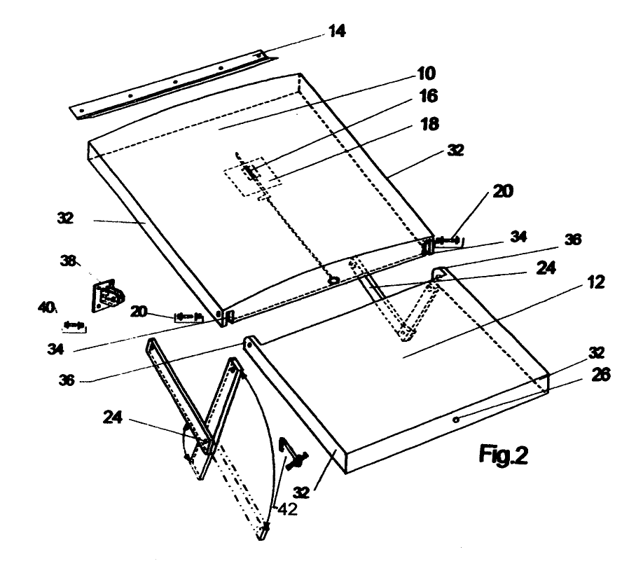

The isomeric view in FIG. 1 illustrates the upper panel 10, and its relationship to window frame 28. It also shows locking brace 24 and deck hinge 38, connected to the window facing, and the upper end of the locking brace connected to lower panel 10.

Drawings in FIG. 2 depict two impact resistant storm panels, upper panel 10, and lower panel 12. It also shows the web extensions 36, located on panel 12, and the machined slots 34, located on the bottom web of the upper panel 10. Web extensions 36 fit into machined slots 34, and they will sandwich locking brace 24. Bolt 20 passes through upper panel 10, locking brace 24, and lower panel 12, and is secured with a flat washer and locking nut, forming the hinge point for the window awning/storm panel system. FIG. 2 also depicts hole 26, located in the bottom flange of the lower panel. Said hole is for securing lower panel in the upright position. FIG. 2 also shows spring loaded latch 16, and panel latches 42 for securing lower panel to the window facing.

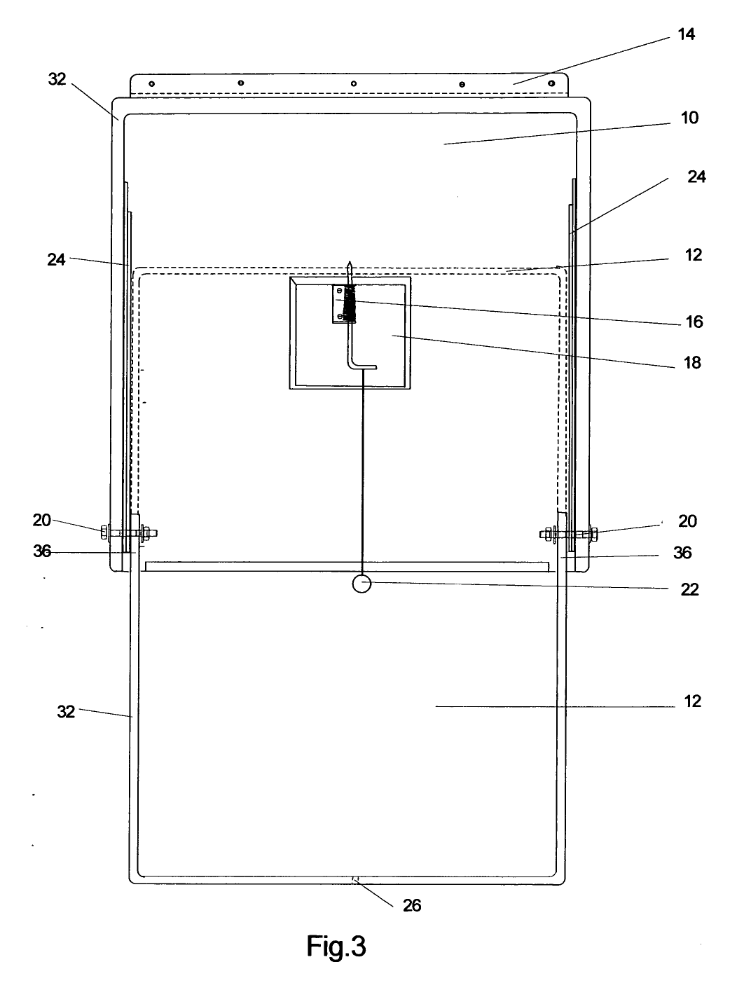

FIG. 3 is a perspective view of the backside of the window awning/storm panel system. Drawings in FIG. 3 depict a piano hinge 14, which will be secured to the top of panel 10. The drawing depicts the spring-loaded latch 16, and latch hole 26. It also shows a view of the locking braces 24, being sandwiched between upper panel 10, lower panel 12, and the securing bolt 20, to form the hinge point.

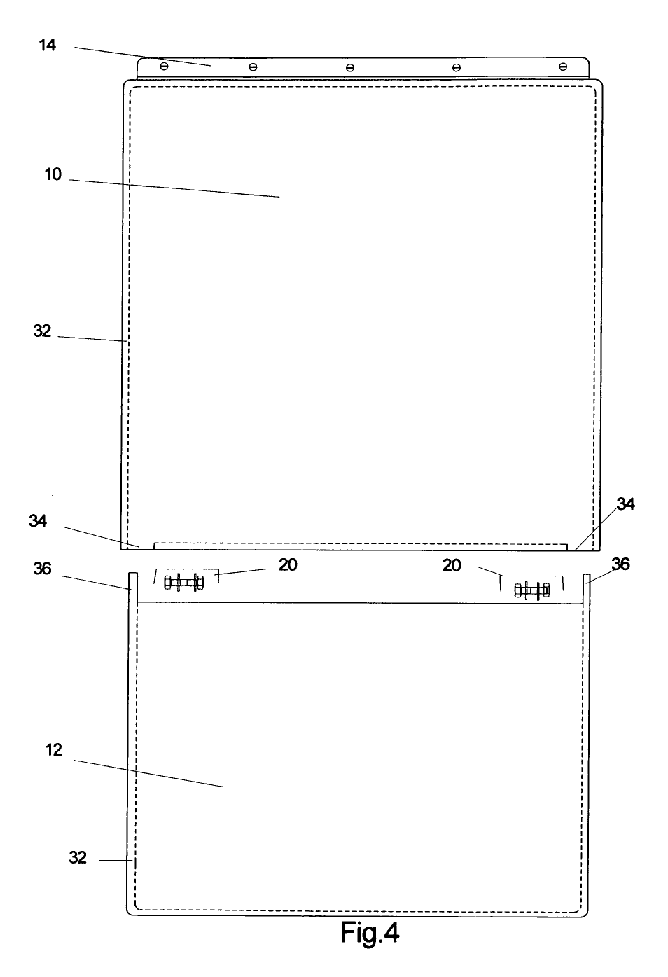

FIG. 4 is a front view of the window awning/storm panel.

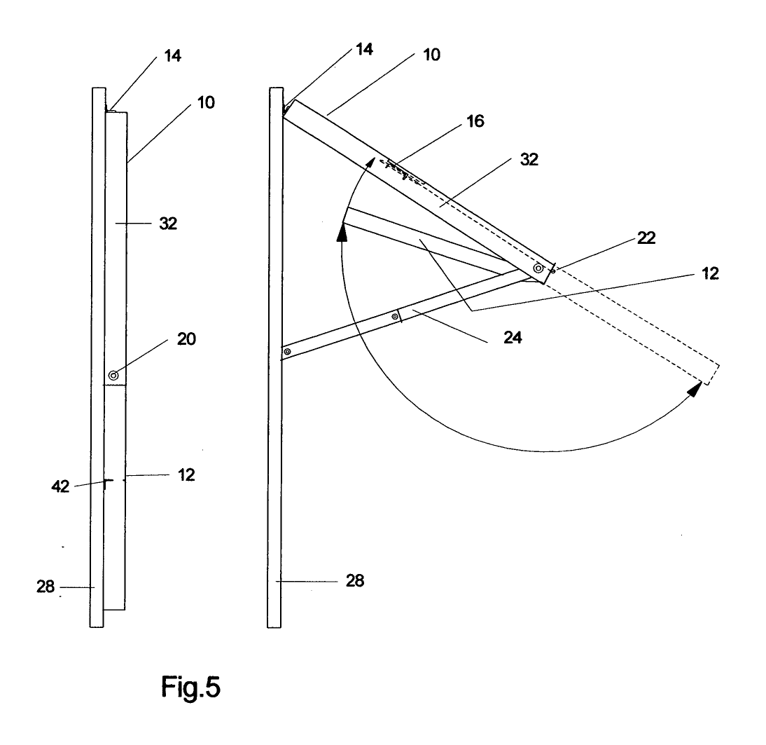

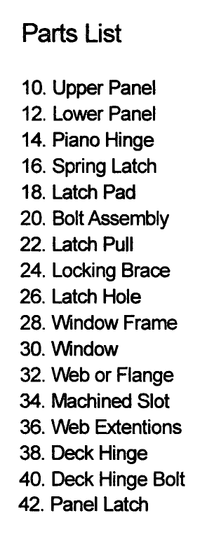

FIG. 5 is a side view of the window awning/storm panel system in both open and closed positions, and also panel latches 42, securing lower panel to the window facing. FIG. 5 also depicts lower panel 12, illustrating how it functions as both a storm panel and a window awning.

It will be appreciated that numerous embodiments and modifications of the above described window awning/storm panel system may be devised by those skilled in the art, and it is intended that these claims cover all such modifications and embodiments as followed in the true spirit and scope of the present window awning/storm panel system.

1. A window awning/storm panel system that easily converts into a storm panel from the inside of the dwelling, said system is comprised of two impact resistant panels, one upper and one lower, a pivoting device to connect the top side of the upper panel to the building, supporting stays for securing the window awning/storm panel system open, one latching device for securing the bottom panel in the upright position, and a small assortment of commonly used bolts, nuts, washers, and fasteners, for securing the window awning/storm panel system to the building, and also for the mechanical operation of the window awning/storm panel system.

2. A window awning/storm panel system of claim 1 wherein both upper and lower panels are constructed of an impact resistant material such as but not limited to, fiberglass or aluminum and said panels can be color coordinated as to the property owners desire.

3. A window awning/storm panel system of claim 1 wherein upper panel is slightly larger than the lower panel and both upper and lower panels are larger than the window.

4. A window awning/storm panel system of claim 2 wherein upper panel will be constructed with a right angle web or flange on the outermost four sides of said panel.

5. A window awning/storm panel system of claim 2 wherein the lower panel will be constructed with a right angle web or flange on the right, left, and bottom sides of the lower panel, and with web extensions on the top side of the lower panel, in order to form a hinge point for the window awning/storm panel system.

6. A window awning/storm panel system of claim 1 wherein the upper panel will be coupled to the window facing with a pivoting device.

7. A window awning/storm panel system of claim 1 wherein the upper panel will incorporate a latching device for the purpose of securing the lower panel in the upright position.

8. A window awning/storm panel system of claim 1 wherein said window awning system will utilize supporting stays, said stays will be secured at one end to the window facing, and the opposite end of the stay will be fastened to the upper panel of the window awning/storm panel system.
